(19) United States
(12) Patent Application Publication
(10) Pub. No.: US 2018/0067364 A1
(43) Pub. Date: Mar. 8, 2018

(54) LIQUID CRYSTAL PANELS

(71) Applicant: Shenzhen China Star Optoelectronics Technology Co. Ltd., Shenzhen, Guangdong (CN)

(72) Inventor: Bo HAI, Shenzhen, Guangdong (CN)

(73) Assignee: Shenzhen China Star Optoelectronics Technology Co. Ltd., Shenzhen, Guangdong (CN)

(21) Appl. No.: 14/915,628

(22) PCT Filed: Jan. 7, 2016
(86) PCT No.: PCT/CN2016/070430

§ 371 Date: Feb. 29, 2016

(30) Foreign Application Priority Data
Nov. 24, 2015 (CN) 201510823899.1

(51) Int. Cl. G02F 1/13363; G02F 1/1335; G02F 1/1337

(52) U.S. Cl. CPC G02F 1/133636; G02F 1/133528; G02F 1/133753; G02F 2001/133531; G02F 2001/133761; G02F 2413/06; G02F 2202/28; G02F 2201/50; G02F 2413/04; G02F 2413/05; G02F 2001/133742

(57) ABSTRACT

A liquid crystal panel includes a first vertical alignment (VA) liquid crystal cell, a first compensation layer and a first polarizer arranged on the first VA liquid crystal cell in turn, and a second compensation layer and a second polarizer arranged below the first VA liquid crystal cell in turn. A slow axis of the first compensation layer is configured to be 135 degrees, an absorption axis of the first PVA polarizer is configured to be 45 degree, a slow axis of the second compensation layer is configured to be 45 degrees, and an absorption axis of the second polarizer is configured to be 135 degrees. In this way, the VA liquid crystal panel may display normally, and the polarizer structure is the same with that of the conventional TN liquid crystal panel.

### BACKGROUND OF THE INVENTION

### 1. Field of the Invention

The present disclosure relates to liquid crystal display technology, and more particularly to a vertical alignment (VA) liquid crystal panel.

### 2. Discussion of the Related Art

With the evolution of optical and semiconductor technology, flat panel displays have been developed. Among the flat panel displays, LCD (Liquid Crystal Display) is characterized by attributes such as high space utilization efficiency, low power consumption, no radiation and low electromagnetic interference, and etc., and thus have been adopted in all aspects of productions.

Currently, LCDs mainly include In Plane Switching (IPS) mode, Twisted Nematic (TN) mode and Vertical Alignment, VA) mode, wherein TN mode is mainly used for small and medium-size LCD displays. For instance, the TN mode liquid crystal display can be used in a notebook, desktop computers, monitors. The VA mode and IPA mode are mainly used for large-size liquid crystal display. For instance, VA mode and IPA mode LCD monitor may be adopted as a display of LCD TVs. With the development of the VA mode, which has been progressively used for small and medium-size LCD display, VA mode liquid crystal displays and TN mode liquid crystal displays may be adopted in applications.

FIG. 1 is a schematic view of conventional VA liquid crystal panel. Referring to FIG. 1, the VA liquid crystal panel includes a Triacetyl Cellulose (TAC), a Poly Vinyl Alcohol (PVA) polarizer 12, a TAC compensation layer 13, a Pressure Sensitive Adhesive (PSA) layer 14, a VA liquid crystal cell 15, a PSA layer 16, a TAC compensation layer 17, a PVA polarizer 18, and a TAC protection layer 19 along a top-down direction. The VA liquid crystal cell 15 is a VA liquid crystal cell of four domains, and the pretwist angles are respectively 45, 135, 225, and 315 degrees. Taking a horizontal viewing angle equaling to 0 degree as a reference, the absorption axis of the PVA polarizer 12 is configured to be 0 degree, the slow axis of the TAC compensation layer 13 is configured to be 90 degrees, the slow axis of the TAC compensation layer 17 is configured to be 0 degree, and the absorption axis of the PVA polarizer 18 is configured to be 90 degrees.

FIGS. 2a-2c are viewing angle distribution diagrams respectively shows the bright state, the dark state, and the contrastness of the liquid crystal panel of FIG. 1. As shown, straight angles of the four concentric circles, from the inside out, are respectively 20, 40, 60, and 80 degrees. The numbers marked outside the concentric circles having the straight angle equaling to 80 degree represent the horizontal viewing angle.

FIG. 3 is a schematic view of one conventional TN liquid crystal panel. The TN liquid crystal panel includes a TAC protection layer 31, a PVA polarizer 32, a TAC compensation layer 33, a PSA layer 34, a TN liquid crystal cell 35, a PSA layer 36, a TAC compensation layer 37, a PVA polarizer 38, and a TAC protection layer 39 along the top-down direction.

Taking a horizontal viewing angle equaling to 35 degrees as a reference, the absorption axis of the PVA polarizer 32 is configured to be 45 degrees, the slow axis of the TAC compensation layer 33 is configured to be 135 degrees, the slow axis of the TAC compensation layer 37 is configured to be 45 degrees, and the absorption axis of the PVA polarizer 38 is configured to be 135 degrees. The TAC compensation layer 33 and the TAC compensation layer 37 are made by materials not limited to TAC compensation materials. For instance, the material capable of compensating the viewing angle, such as Cyclo-olefin polymer (COP) may be adopted.

In view of FIGS. 1 and 3, the polarizer structure of the VA LCD is different from that of the TN LCD, and thus the structure cannot be shared. It is critical to provide a shared polarizer structure that can be adopted by the VA LCDs and the TN LCDs at the same time.

### SUMMARY

In order to overcome the above problems, the present disclosure relates to a liquid crystal panel, wherein the polarizer structure may be shared with the polarizer structure of the TN liquid crystal panel.

In one aspect, a liquid crystal panel includes: a first vertical alignment (VA) liquid crystal cell, a first compensation layer and a first polarizer arranged on the first VA liquid crystal cell in turn, and a second compensation layer and a second polarizer arranged below the first VA liquid crystal cell in turn, wherein a slow axis of the first compensation layer is configured to be 135 degrees, an absorption axis of the first PVA polarizer is configured to be 45 degree, a slow axis of the second compensation layer is configured to be 45 degrees, and an absorption axis of the second polarizer is configured to be 135 degrees.

Wherein a first adhesive layer is arranged between the first VA liquid crystal cell and the first compensation layer, and a second adhesive layer is arranged between the first VA liquid crystal cell and the second compensation layer.

Wherein a first protection layer is arranged on the first polarizer, and a second protection layer is arranged below the second polarizer.

Wherein the first VA liquid crystal cell is a VA liquid crystal cell of multi-domain.

Wherein the first VA liquid crystal cell is a VA liquid crystal cell of four-domains, and pretwist angles are respectively 0, 90, 180, and 270 degrees.

In another aspect, a liquid crystal panel includes: a second VA liquid crystal cell, a third compensation layer and a third polarizer arranged on the second VA liquid crystal cell in turn, and a fourth compensation layer and a fourth polarizer arranged below the second VA liquid crystal cell in turn, wherein: a slow axis of the third compensation layer is configured to be 45 degrees, an absorption axis of the third polarizer is configured to be 135 degree, a slow axis of the fourth compensation layer is configured to be 135 degree, and an absorption axis of the fourth polarizer is configured to be 45 degrees.

Wherein a third adhesive layer is arranged between the second VA liquid crystal cell and the third compensation layer, and a fourth adhesive layer is arranged between the second VA liquid crystal cell and the fourth compensation layer.

Wherein a third protection layer is arranged on the third polarizer, and a fourth protection layer is arranged below the fourth polarizer.

Wherein the second VA liquid crystal cell is a VA liquid crystal cell of multi-domain.

Wherein the second VA liquid crystal cell is a VA liquid crystal cell of four-domains, and pretwist angles are respectively 0, 90, 180, and 270 degrees.

In view of the above, the VA liquid crystal panel may display normally, and the polarizer structure is the same with that of the conventional TN liquid crystal panel.

### BRIEF DESCRIPTION OF THE DRAWINGS

FIG. 1 is a schematic view of one conventional VA liquid crystal panel.

FIGS. 2a-2c are viewing angle distribution diagrams respectively shows for the bright state, the dark state, and the contrastness of the liquid crystal panel of FIG. 1.

FIG. 3 is a schematic view of one conventional TN liquid crystal panel.

FIG. 4 is a schematic view of the liquid crystal panel in accordance with a first embodiment.

FIG. 5 is a schematic view of the liquid crystal panel in accordance with a second embodiment.

FIGS. 6a-6c are viewing angle distribution diagrams respectively shows for the bright state, the dark state, and the contrastness of the liquid crystal panel of FIGS. 4 and 5.

### DETAILED DESCRIPTION OF THE EMBODIMENTS

Various example embodiments will now be described more fully with reference to the accompanying drawings in which some example embodiments are shown. In the drawings, the thicknesses of layers and regions may be exaggerated for clarity. In the following description, in order to avoid the known structure and/or function unnecessary detailed description of the concept of the invention result in confusion, well-known structures may be omitted and/or functions described in unnecessary detail.

It should be noted that the relational terms herein, such as “first” and “second”, are used only for differentiating one entity or operation, from another entity or operation, which, however do not necessarily require or imply that there should be any real relationship or sequence.

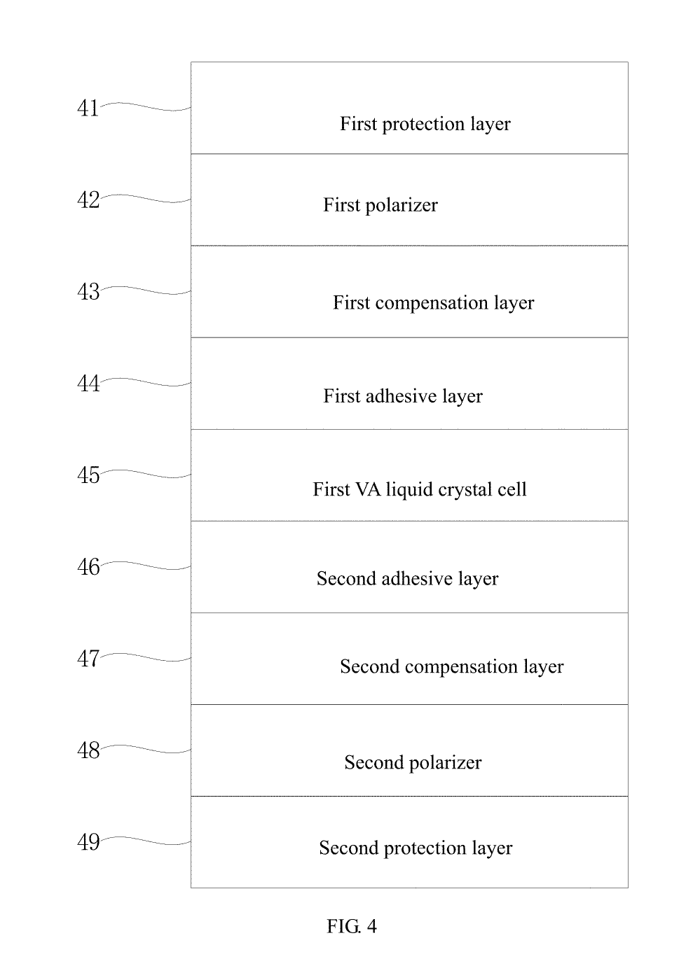

FIG. 4 is a schematic view of the liquid crystal panel in accordance with a first embodiment. The liquid crystal panel includes a first VA liquid crystal cell 45, a first compensation layer 43 and a first polarizer 42 arranged on the first VA liquid crystal cell 45 in turn, and a second compensation layer 47 and a second polarizer 48 arranged below the first VA liquid crystal cell 45 in turn. Taking a horizontal viewing angle equaling to 0 degree as a reference, the slow axis of the first compensation layer 43 is configured to be 135 degrees, the absorption axis of the first PVA polarizer 42 is configured to be 45 degree, the slow axis of the second compensation layer 47 is configured to be 45 degrees, and the absorption axis of the second polarizer 48 is configured to be 135 degrees.

In the embodiment, the first VA liquid crystal cell 45 may include a thin film transistor (TFT) array substrate, a color filter (CF) substrate on the TFT array substrate, and a liquid crystal layer between the TFT array substrate and the CF substrate. Further, the first VA liquid crystal cell 45 may be Multi-Domain Vertical Alignment (MVA) liquid crystal cell. In the embodiment, the first VA liquid crystal cell 45 is of four domains. That is, the pretwist angles are respectively 0, 90, 180, and 270 degrees. In another example, the first VA liquid crystal cell 45 may be, but not limited to, of eight domains.

The first compensation layer 43 and the second compensation layer 47 are TAC compensation layers, and the configuration may be determined by the angle of the slow axis. The first polarizer 42 and the second polarizer 48 are PVA layers made by PVA, and the configuration may be determined by the angle of the absorption axis.

In the embodiment, in order to protect the first polarizer 42 and the second polarizer 48, the liquid crystal panel further includes: A first protection layer 41 is arranged on the first polarizer 42 to protect the first polarizer 42 and to enhance the mechanical performance of the first polarizer 42 so as to prevent the first polarizer 42 from being retracted; and a second protection layer 49 arranged below the second polarizer 48 to protect the second polarizer 48 and to enhance the mechanical performance of the second polarizer 48 so as to prevent the second polarizer 48 from being retracted.

The first protection layer 41 and the second protection layer 49 are TAC protection layers. It is to be noted that, in other embodiment, the liquid crystal panel may not include the first protection layer 41 and the second protection layer 49.

Further, the liquid crystal panel may include: a first adhesive layer 44 between the first VA liquid crystal cell 45 and the first compensation layer 43, and a second adhesive layer 46 between the first VA liquid crystal cell 45 and the second compensation layer 47. The first adhesive layer 44 and the second adhesive layer 46 are Pressure Sensitive Adhesive (PSA) layers. It is to be noted that, in other embodiment, the liquid crystal panel may not include the first adhesive layer 44 and the second adhesive layer 46.

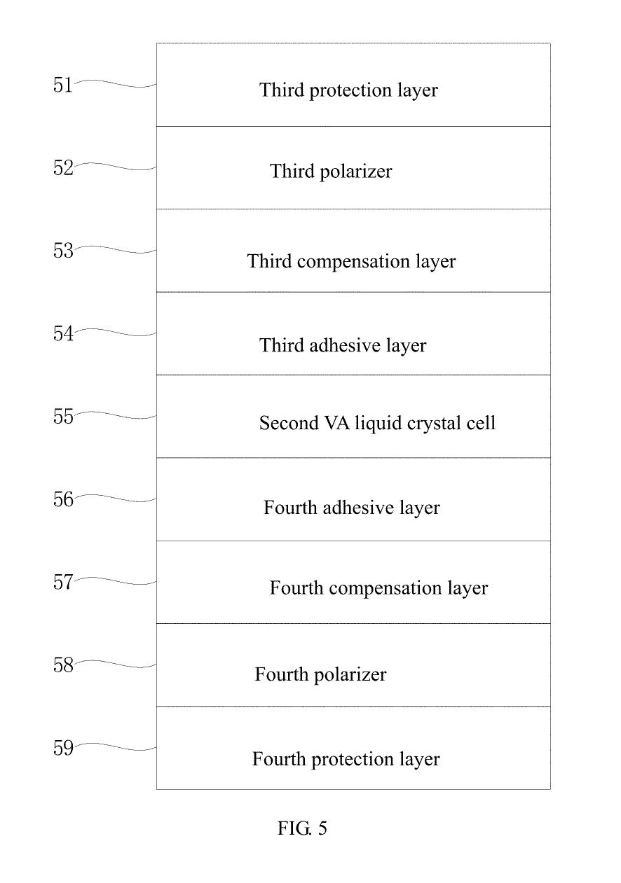

FIG. 5 is a schematic view of the liquid crystal panel in accordance with a second embodiment. The liquid crystal panel includes a second VA liquid crystal cell 55, a third compensation layer 53 and a third polarizer 52 arranged on the second VA liquid crystal cell 55 in turn, and a fourth compensation layer 57 and a fourth polarizer 58 arranged below the second VA liquid crystal cell 55 in turn.

Taking a horizontal viewing angle equaling to 0 degree as a reference, the slow axis of the third compensation layer 53 is configured to be 45 degrees, the absorption axis of the third polarizer 52 is configured to be 135 degree, the slow axis of the fourth compensation layer 57 is configured to be 135 degree, and the absorption axis of the fourth polarizer 58 is configured to be 45 degrees.

In the embodiment, the second VA liquid crystal cell 55 may include the TFT array substrate, the CF substrate on the TFT array substrate, and the liquid crystal layer between the two substrate. Further, the first VA liquid crystal cell 55 may be Multi-Domain Vertical Alignment (MVA) liquid crystal cell. In the embodiment, the first VA liquid crystal cell 45 is of four domains. That is, the pretwist angles are respectively 0, 90, 180, and 270 degrees. In another example, the first VA liquid crystal cell 45 may be, but not limited to, of eight domains.

The third compensation layer 53 and the fourth compensation layer 57 are TAC compensation layers, and the configuration may be determined by the angle of the slow axis. The first polarizer 52 and the second polarizer 58 are PVA layers made by PVA, and the configuration may be determined by the angle of the absorption axis.

In the embodiment, in order to protect the third polarizer 52 and the fourth polarizer 58, the liquid crystal panel further includes: A third protection layer 51 is arranged on the third polarizer 52 to protect the third polarizer 52 and to enhance the mechanical performance of the third polarizer 52 so as to prevent the third polarizer 52 from being retracted; and a fourth protection layer 58 arranged below the fourth polarizer 58 to protect the fourth polarizer 58 and to enhance the mechanical performance of the fourth polarizer 58 so as to prevent the fourth polarizer 58 from being retracted.

The third protection layer 51 and the fourth protection layer 59 are TAC protection layers. It is to be noted that, in other embodiment, the liquid crystal panel may not include the third protection layer 51 and the fourth protection layer 59.

Further, the liquid crystal panel may include: a third adhesive layer 54 between the second VA liquid crystal cell 55 and the third compensation layer 53, and a fourth adhesive layer 56 between the second VA liquid crystal cell 55 and the fourth compensation layer 56. The third adhesive layer 54 and the fourth adhesive layer 56 are Pressure Sensitive Adhesive (PSA) layers. It is to be noted that, in other embodiment, the liquid crystal panel may not include the third adhesive layer 54 and the fourth adhesive layer 56.

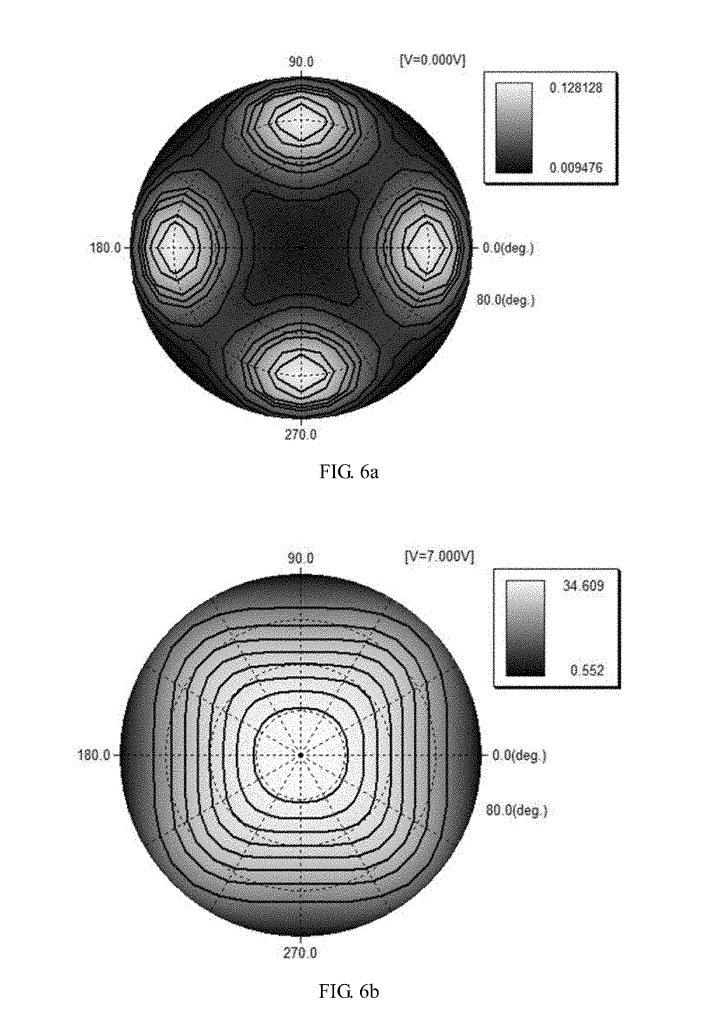

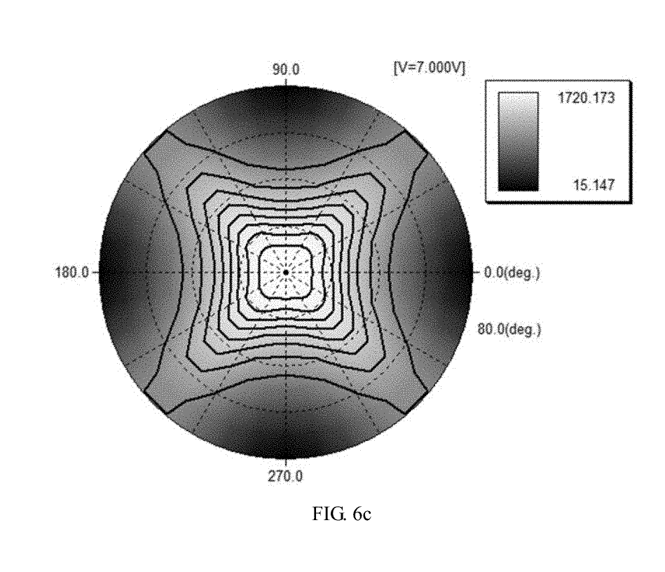

FIGS. 6a-6c are viewing angle distribution diagrams respectively shows for the bright state, the dark state, and the contrastness of the liquid crystal panel of FIGS. 4 and 5. As shown, straight angles of the four concentric circles, from the inside out, are respectively 20, 40, 60, and 80 degrees. The numbers marked outside the concentric circles having the straight angle equaling to 80 degree represent the horizontal viewing angle.

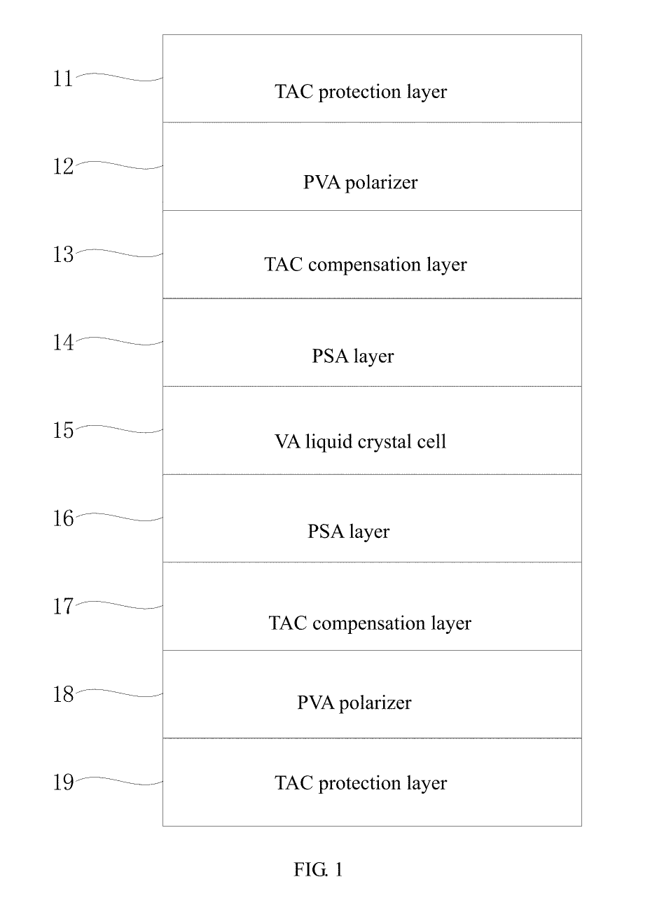

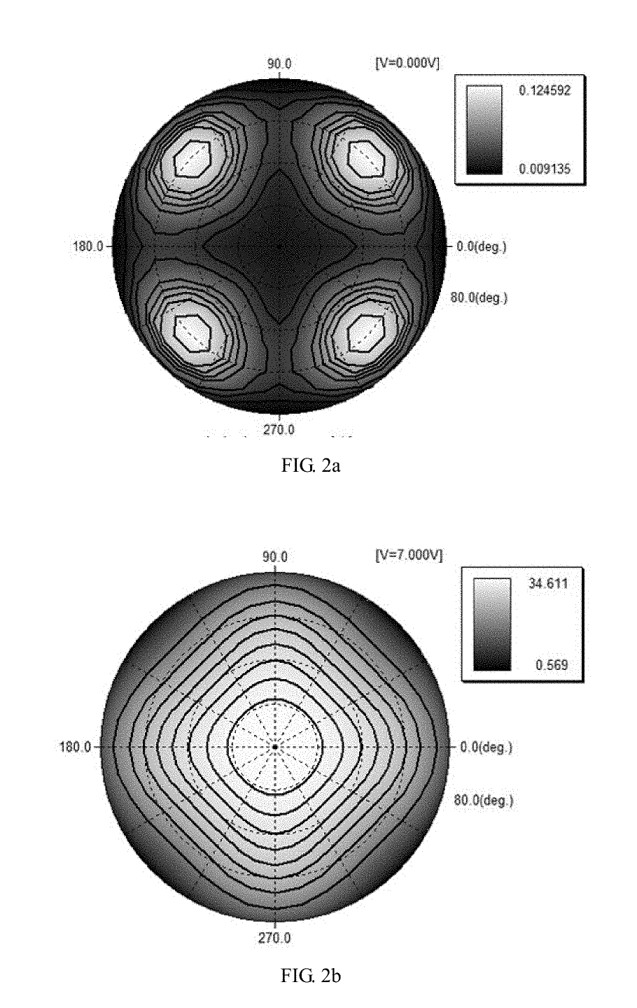

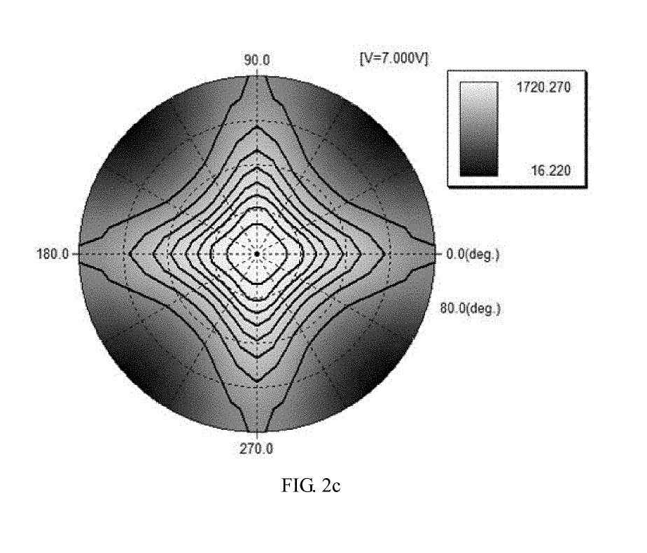

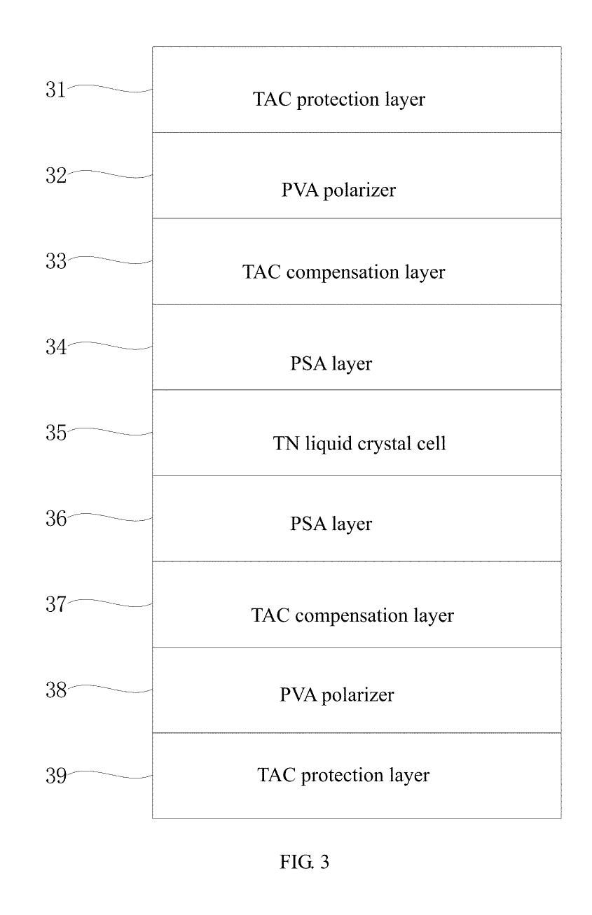

In view of FIGS. 2a and 6a, the brightness of the dark state with respect to all of the viewing angles of the liquid crystal panel in FIGS. 4 and 5 is the same with that shown in FIG. 1. In addition, when compared with FIG. 1, the distribution of the brightness of the dark state with respect to all of the viewing angles of FIGS. 4 and 5 have deviated for 45 degrees.

In view of FIGS. 2b and 6b, the brightness of the bright state with respect to all of the viewing angles of the liquid crystal panel in FIGS. 4 and 5 is the same with that shown in FIG. 1. In addition, when compared with FIG. 1, the distribution of the brightness of the bright state with respect to all of the viewing angles of FIGS. 4 and 5 have deviated for 45 degrees.

In view of FIGS. 2c and 6c, the contrastness of with respect to all of the viewing angles of the liquid crystal panel in FIGS. 4 and 5 is the same with that shown in FIG. 1. In addition, when compared with FIG. 1, the contrastness with respect to all of the viewing angles of FIGS. 4 and 5 have deviated for 45 degrees.

In view of the above, the liquid crystal panel in FIGS. 1 and 2 may display normally. In addition, the polarizer structure of the liquid crystal panels in the first and the second embodiments is the same with the polarizer structure adopted by the TN liquid crystal panel.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal panel, comprising:
a first vertical alignment (VA) liquid crystal cell, a first compensation layer and a first polarizer arranged on the first VA liquid crystal cell in turn, and a second compensation layer and a second polarizer arranged below the first VA liquid crystal cell in turn, wherein
a slow axis of the first compensation layer is configured to be 135 degrees, an absorption axis of the first PVA polarizer is configured to be 45 degree, a slow axis of the second compensation layer is configured to be 45 degrees, and an absorption axis of the second polarizer is configured to be 135 degrees.

2. The liquid crystal panel as claimed in claim 1, wherein a first adhesive layer is arranged between the first VA liquid crystal cell and the first compensation layer, and a second adhesive layer is arranged between the first VA liquid crystal cell and the second compensation layer.

3. The liquid crystal panel as claimed in claim 2, wherein a first protection layer is arranged on the first polarizer, and a second protection layer is arranged below the second polarizer.

4. The liquid crystal panel as claimed in claim 1, wherein the first VA liquid crystal cell is a VA liquid crystal cell of multi-domain.

5. The liquid crystal panel as claimed in claim 2, wherein the first VA liquid crystal cell is a VA liquid crystal cell of multi-domain.

6. The liquid crystal panel as claimed in claim 3, wherein the first VA liquid crystal cell is a VA liquid crystal cell of multi-domain.

7. The liquid crystal panel as claimed in claim 4, wherein the first VA liquid crystal cell is a VA liquid crystal cell of four-domains, and pretwist angles are respectively 0, 90, 180, and 270 degrees.

8. The liquid crystal panel as claimed in claim 5, wherein the first VA liquid crystal cell is a VA liquid crystal cell of four-domains, and pretwist angles are respectively 0, 90, 180, and 270 degrees.

9. The liquid crystal panel as claimed in claim 6, wherein the first VA liquid crystal cell is a VA liquid crystal cell of four-domains, and pretwist angles are respectively 0, 90, 180, and 270 degrees.

10. A liquid crystal panel, comprising:
a second VA liquid crystal cell, a third compensation layer and a third polarizer arranged on the second VA liquid crystal cell in turn, and a fourth compensation layer and a fourth polarizer arranged below the second VA liquid crystal cell in turn, wherein:
a slow axis of the third compensation layer is configured to be 45 degrees, an absorption axis of the third polarizer is configured to be 135 degree, a slow axis of the fourth compensation layer is configured to be 135 degree, and an absorption axis of the fourth polarizer is configured to be 45 degrees.

11. The liquid crystal panel as claimed in claim 10, wherein a third adhesive layer is arranged between the second VA liquid crystal cell and the third compensation layer, and a fourth adhesive layer is arranged between the second VA liquid crystal cell and the fourth compensation layer.

12. The liquid crystal panel as claimed in claim 11, wherein a third protection layer is arranged on the third polarizer, and a fourth protection layer is arranged below the fourth polarizer.

13. The liquid crystal panel as claimed in claim 10, wherein the second VA liquid crystal cell is a VA liquid crystal cell of multi-domain.

14. The liquid crystal panel as claimed in claim 11, wherein the second VA liquid crystal cell is a VA liquid crystal cell of multi-domain.

15. The liquid crystal panel as claimed in claim 12, wherein the second VA liquid crystal cell is a VA liquid crystal cell of multi-domain.

16. The liquid crystal panel as claimed in claim 13, wherein the second VA liquid crystal cell is a VA liquid crystal cell of four-domains, and pretwist angles are respectively 0, 90, 180, and 270 degrees.

17. The liquid crystal panel as claimed in claim 14, wherein the second VA liquid crystal cell is a VA liquid crystal cell of four-domains, and pretwist angles are respectively 0, 90, 180, and 270 degrees.

18. The liquid crystal panel as claimed in claim 15, wherein the second VA liquid crystal cell is a VA liquid crystal cell of four-domains, and pretwist angles are respectively 0, 90, 180, and 270 degrees.
